(19) United States
(12) Patent Application Publication
(10) Pub. No.: US 2015/0051273 A1
(43) Pub. Date: Feb. 19, 2015

(54) USE OF DELPHINIDIN AGAINST STAPHYLOCOCCUS AUREUS

(71) Applicant: Sapiotec GmbH, Wurzburg (DE)

(72) Inventors: Norbert Roewer, Wurzburg (DE); Jens Broscheit, Wurzburg (DE)

(21) Appl. No.: 14/389,492

(22) PCT Filed: Mar. 28, 2013
(86) PCT No.: PCT/EP2013/056725

§ 371 Date: Sep. 30, 2014

(30) Foreign Application Priority Data
Mar. 30, 2012 (EP) 12002352.8

(51) Int. Cl. A01N 43/16

(52) U.S. Cl. CPC A01N 43/16
USPC 514/456

(57) ABSTRACT

The invention relates to the use of delphinidin or salts thereof, which is aimed at bacteria selected from the group comprising antibiotic-resistant Staphylococcus aureus and antibiotic-sensitive Staphylococcus aureus and at least partially neutralizes said bacteria, and methods for treating objects with delphinidin or salts thereof.

The invention relates to the use of the anthocyanidin delphinidin or its salts for controlling antibiotics-resistant and antibiotics-sensitive bacteria.

Anthocyanidins are zymochrome dyes which occur in the majority of higher land plants. Anthocyanidins are sugar-free (aglycones) and closely related to the sugar-containing anthocyans (glycosides), both of which come under the generic heading of the anthocyans. Anthocyanidins are dyes and possess antioxidative properties.

Antibiotics-resistant and antibiotics-sensitive bacteria are frequently found where antibiotics are used continually. Antibiotics-resistant and antibiotics-sensitive bacteria of the species Staphylococcus aureus are among the most dangerous pathogens of hospital-acquired, i.e., nosocomial infections, taken in not only via the skin and mucous membranes but also through contaminated medical instruments or foods.

Particularly because of the increased consumption of broad-spectrum antibiotics in the treatment of bacterial infectious diseases, an increase is being recorded in multiresistant bacteria, meaning that there is no longer an effective antibiotic available in the treatment of animals or patients infected with these bacteria. In humans and animals, antibiotics-resistant bacteria can trigger severe generalized infections. This is especially the case in immunosuppressed patients.

It is an object of the present invention to provide an effective agent for the prophylaxis and treatment of bacterial infectious diseases.

A further object of the invention is to provide an effective agent for controlling antibiotics-resistant and antibiotics-sensitive bacteria of the species Staphylococcus aureus.

These objects are achieved through the use of delphinidin or its salts as claimed in claim 1, a method as claimed in claim 5, and the uses as claimed in claims 11 and 12. Advantageous embodiments of the invention are disclosed in the dependent claims.

First of all, a number of terms used in the context of the invention will be elucidated.

“Antibiotics” are medicaments for treating bacterial infectious diseases. The group of the antibiotics encompasses in particular the β-lactam antibiotics (including penicillin, cephalosporins, carbapenems, and monobactams), quinolones, tetracyclines, aminoglycosides, erythromycin, sulfonamides, and vancomycin. “Antibiotics-resistant bacterium” and “antibiotics-sensitive bacterium” mean that the bacterium is resistant to at least one antibiotic and/or has only reduced sensitivity toward at least one antibiotic. Multiresistant Staphylococcus aureus strains which are resistant to all presently commercially available β-lactam antibiotics and in most cases also possess resistances toward other classes of antibiotics, as against quinolones, tetracyclines, aminoglycosides, erythromycin, and sulfonamides, are referred to collectively in the art by the term “MRSA” (multi-resistant Staphylococcus aureus or methicillin-resistant Staphylococcus aureus). Therapy of MRSA patients takes place customarily with the reserve antibiotic vancomycin, with resistances even against this antibiotic being already prevalent (“VRSA”—vancomycin-resistant Staphylococcus aureus), with the consequence of a considerable demand for alternative medicaments for treating bacterial infectious diseases.

In accordance with the invention, the composition or the complex as claimed in any of claims 1 to 7 or the aqueous solution or the solid as claimed in claim 8 is used for treating an object or individual suspected of being contaminated with bacteria selected from the group consisting of antibiotics-resistant Staphylococcus aureus and antibiotics-sensitive Staphylococcus aureus. The purpose of this treatment is the at least partial neutralization of the bacteria. The neutralization embraces any kind of neutralization, encompassing, for example, bacteriostatic neutralization, bactericidal neutralization, and mixed bacteriostatic-bactericidal neutralization. The term “composition or complex comprising at least one anthocyanidin” includes an anthocyanidin as such without further components.

With a view to application in the health sector, the inventive composition or the complex as claimed in any of claims 1 to 7 or the aqueous solution or the solid as claimed in claim 8 serves for use in the treatment of prophylaxis of humans or animals suspected of being infected with antibiotics-resistant or antibiotics-sensitive bacteria of the species Staphylococcus aureus. The bacterial infection causes, in particular, diseases with symptoms such as skin infections, including boils and carbuncles, pyomyositis, pneumonia, endocarditis, toxic shock syndrome, sepsis, and mastitis. Particularly in the case of immunosuppressed patients, severe generalized infections may be triggered by antibiotics-resistant or antibiotics-sensitive bacteria of the species Staphylococcus aureus.

With a view to the food, feed, and disinfection sector, the term “object” encompasses nonlive animals, apparatus and/or installations and/or equipment and/or instruments for medical applications, food processing, the military, protective equipment, domestic objects, building installations, and construction works. “Nonlive animals” are, in particular, killed, slaughtered animals or parts of these animals, as for example the body of a bovine, or a part thereof, the body of a pig, or a part thereof, a poultry body or a part thereof, and the body of a water-dwelling animal, or a part thereof. The “object” may in particular be a food and/or feed, as for example a meat product, a processed meat product, a dairy product, vegetables and parts thereof, and fruit and parts thereof.

“Neutralization” in the sense of the present invention means the destruction or disintegration (lysis) or inactivation (e.g., the loss of infective potential), or prevention of reproduction, of a pathogen, or the prevention of the pathogen-mediated biofilm formation, particularly of antibiotics-resistant or antibiotics-sensitive bacteria of the species Staphylococcus aureus. The composition of the invention or the complex of the invention may be administered or applied by sprayed application, powdering, injection, coating by means of a gel, of a dressing, of a plaster or patch or the like to the area it is suspected is infected. In the case of the treatment of humans or animals, depending on the clinical picture, the composition of the invention or the complex of the invention may be administered systemically or locally. Corresponding techniques for formulation and administration are known from the prior art; see, for example, “Remington's Pharmaceutical Sciences” (Mack Publishing Co., Easton Pa.). For example, the compositions and complexes of the invention may be administered to a subject intravenously by means of a pharmaceutically acceptable vehicle (e.g., physiological saline solution). An appropriate formulation for injection is a formulation in aqueous solution, preferably in physiologically acceptable buffers (e.g., Hanks solution, Ringer solution, or physiologically buffered saline solution). For parenteral administration, including intravenous, subcutaneous, intramuscular, and intraperitoneal administration, an aqueous or oily solution or a solid formulation is likewise contemplated.

“Biofilm” is an assembly of microorganisms (e.g., bacteria), embedded in an extracellular polysaccharide matrix or protein matrix, produced by the microorganisms, on a surface. The organization of bacteria in a biofilm leads to a significant increase in the capacity of the entire population to resist a very wide variety of influences. Biofilms caused by bacteria on teeth, on the gums, on the urinary tracts, on the digestive tract, or on medical devices such as catheters and prostheses lead frequently to severe infections (Costerton et al., Annu Rev. Microbiol. 1995; 49: 711-45).

“Salt” or “pharmaceutically acceptable salt” stands for any salt, acceptable from the pharmaceutical standpoint, of a compound of the present invention that is able to release the pharmaceutically active ingredient or its active metabolite after administration. Salts of the compositions and complexes of the present invention may derive from organic or inorganic acids and bases.

The anthocyanidin may be used in “pure form” or “purified”, meaning that unwanted components have been removed.

“Anthocyanidins” have the basic structure reproduced below.

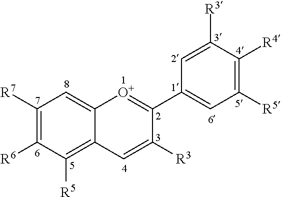

The substituents in this formula are selected from the group consisting of hydrogen, hydroxyl group, and methoxy group.

Cyclodextrins, which may be complexed in accordance with the invention with the anthocyanidin, are cyclic oligosaccharides of α-1,4-glycosidically linked glucose molecules. β-Cyclodextrin possesses seven glucose units. In the case of a sulfoalkyl ether-β-cyclodextrin, hydroxyl groups of the glucose unit are etherified in a sulfoalkyl alcohol. Generally, in accordance with the invention, only some of the 21 hydroxyl groups of a β-cyclodextrin are etherified. The preparation of sulfoalkyl ether-cyclodextrins is familiar to the skilled person and is described in U.S. Pat. No. 5,134,127 or WO 2009/134347 A2, for example.

In the case of cyclodextrins in the prior art, sulfoalkyl ether groups are used to increase the hydrophilicity or water-solubility. The invention has recognized that the sulfoalkyl ether groups make a particular contribution to increasing the stability of the complex of anthocyanidins and correspondingly substituted β-cyclodextrin, and so substantially improve the storage stability and formulatability of the particularly oxidation-sensitive anthocyanidins. The complex of the invention may be formulated as a storage-stable aqueous solution or solid, as will be shown in more detail below.

Particularly preferred in accordance with the invention is complexing with a sulfobutyl ether-β-cyclodextrin (SEB-β-CD). One attempt at an explanation for this, without restricting the scope of protection, is that the negatively charged sulfobutyl units interact electrostatically with the positively charged anthocyanidins, and, among the alkyl groups, the butyl group possesses the optimum length sterically to permit such interaction.

The degree of substitution of the cyclodextrin by sulfoalkyl ether groups is preferably 3-8, more preferably 4-8, more preferably 5 to 8, more preferably 6 to 7.

Suitable sulfobutyl ether-β-cyclodextrins having an average degree of substitution of 6 to 7 are described in the stated WO 2009/134347 A2, for example, and are available commercially under the trade name Captisol®. Likewise possible for use are corresponding cyclodextrins having a degree of substitution of 4-5, as for example 4.2.

The anthocyanidins, used in accordance with the invention in pure form, salt form, or complexed form, are preferably selected from the group consisting of aurantinidin, cyanidin, delphinidin, europinidin, luteolinidin, pelargonidin, malvidin, peonidin, petunidin and rosinidin. The chemical structure corresponds to the formula I reproduced above, with the following substitution pattern

| | R^{3′} | R^{4′} | R^{5′} | R³ | R⁵ | R⁶ | R⁷ |
|---|---|---|---|---|---|---|---|
| Aurantinidin | —H | —OH | —H | —OH | —OH | —OH | —OH |
| Cyanidin | —OH | —OH | —H | —OH | —OH | —H | —OH |
| Delphinidin | —OH | —OH | —OH | —OH | —OH | —H | —OH |
| Europinidin | —OCH₃ | —OH | —OH | —OH | —OCH₃ | —H | —OH |
| Luteolinidin | —OH | —OH | —H | —OH | —OH | —H | —OH |
| Pelargonidin | —H | —OH | —H | —OH | —OH | —H | —OH |
| Malvidin | —OCH₃ | —OH | —OCH₃ | —OH | —OH | —H | —OH |
| Peonidin | —OCH₃ | —OH | —H | —OH | —OH | —H | —OH |
| Petunidin | —OH | —OH | —OCH₃ | —OH | —OH | —H | —OH |
| Rosinidin | —OCH₃ | —OH | —H | —OH | —OH | —H | —OCH₃ |

Particularly preferred in the context of the invention is delphinidin.

The invention further provides an aqueous solution of the composition of the invention or of the complex of the invention.

The complex of the invention and also a corresponding aqueous solution comprises the following steps:
a) preparing an aqueous solution of the sulfoalkyl ether-β-cyclodextrin,
b) adding the anthocyanidin and mixing to produce the complex.

Prepared preferably in step a) is an aqueous solution which comprises 5 to 10 wt % of the cyclodextrin used. In the context of the invention it is particularly preferable for the pH of the aqueous solution, during or after, but preferably before, the addition of the anthocyanidin, preferably delphinidin, to be adjusted to a pH of 7 or less, preferably 6 or less, more preferably 5 or less, more preferably 4 to 5. It has emerged that at this pH, a higher concentration of the complex in aqueous solution can be established.

The concentration of the anthocyanidin, calculated as chloride, is preferably at least 0.5 mg/ml, more preferably at least 1.0 mg/ml, more preferably at least 1.5 mg/ml, more preferably 2.0 mg/ml. The particularly preferred concentration range of at least 2.0 mg/ml can be established, in a preferred embodiment, in particular in an aqueous solution having a pH of between 4 and 5.

For the purposes of the inventive producing, the mixing of the constituents of the aqueous solution may take place by stirring; preferred time periods for the mixing are 2 to 20 h. Preference is given to operating in the dark, in order to prevent light-induced oxidation.

The invention further provides a solid comprising a complex of the invention which is obtainable in accordance with the invention by removal of the solvent from an aqueous solution of the invention. The removal may be accomplished preferably by freeze-drying (lyophilization). Both the aqueous solution of the invention and the solid possess a high storage stability.

The invention will now be described hereinafter further, in the examples, with reference to the appended figures, without being confined thereto.

I. Preparation of a Complex of the Anthocyanidin Delphinidin and Cyclodextrins

1. Materials Used:

The following cyclodextrins are used:

| | |
|---|---|
| α-CD | ID No: CYL-2322 |
| β-CD | ID No: CYL-3190 |
| γ-CD | ID No: CYL-2323 |
| (2-Hydroxypropyl)-β-CD | ID No: L-043/07 |
| Sulfobutyl ether-β-CD | ID No: 47K010111 |

Dephinidin chloride was acquired from the company Extrasynthese.

2. Determining the Delphinidin Content

The delphinidin chloride content of the delphinidin-containing compositions was determined using a reversed-phase HPLC technique. The following reagents were employed here:

Purified water

Methanol for chromatography

Formic acid, p.a.

1 M hydrochloric acid as volumetric solution.

The column used was a Waters X Bridge™ C18, 35 μl, 150 mm×4.6 mm.

The mobile phases were as follows:

Channel A: water 950 ml, methanol 50 ml, formic acid 10 ml

Channel B: water 50 ml, methanol 950 ml, formic acid 10 ml

The following gradient program was used:

| Time | Percent |
|---|---|
| [min] | channel B |
| 0 | 0 |
| 5 | 0 |
| 25 | 60 |
| 30 | 100 |

Stop time: 35 min

Post-time: 8 min

Flow rate: 1 ml/min

Injection volume: 20 μl

Column temperature: 30° C. +/−2° C.

UV-Vis detector: 530 μm for the assay, 275 μm for the detection of impurities

Integrator: area

Solutions and Sample Preparation:

Diluent solution 1: mixture of 100 ml methanol and 2.6 ml 1 M HCL

Diluent solution 2: mixture of 100 ml 40 percent strength methanol and 2.6 ml 1 M HCL

Calibrating solution: a reference solution of delphinidin was prepared by weighing out 10 mg of delphinidin chloride into a 10 ml flask and dissolving it in diluent solution 1. Dissolution was followed by approximately 10-fold dilution with diluent solution 2, to produce an approximate concentration of 0.1 mg/ml.

The control calibrating solution was prepared in the same way. The calibrating solutions were analyzed immediately by HPLC, since delphinidin chloride in solution is unstable.

Preparation of the Test Solutions:

For determining the delphinidin content of solids produced in accordance with the invention (for production see later on below), around 50 mg of this composition were weighed into a 10 ml flask. This quantity was subsequently dissolved in diluent solution 2, and diluted further with the same diluent solution 2 to give an approximate delphinidin concentration of 0.1 mg/ml.

The determination of the delphinidin content in the samples was calculated with the aid of the Agilent ChemStation software, employing calibration with the external standard described.

### EXAMPLE 1

### Complexing of delphinidin with SBE-β-CD

In this example, the complexing of delphinidin by different cyclodextrins and the solubility of the complex in aqueous solution are investigated.

Neutral aqueous solutions were prepared, containing 10 wt % of the respective cyclodextrin. In the case of β-CD, a concentration of only 2 wt % was selected, on account of the deficient solubility.

5 ml each of the aqueous cyclodextrin solutions and of pure water were introduced into glass flasks. Then an excess of delphinidin chloride was added. The required excess quantity was 10 mg for the solutions of α-, β-, and γ-cyclodextrin, and 15 mg for the solutions of HPBCD (2-hydroxypropyl-β-cyclodextrin) and SBE-β-CD.

The suspensions were stirred in the dark at 30° C. for 20 h. This was followed by filtration through a membrane filter with a 0.22 μm pore size.

The solubilities achievable are reproduced in Table 1 below.

| | Cyclodextrin | Delphinidin |
|---|---|---|
| Cyclodextrin | concentration | chloride |
| — | 0 | 0.07 mg/ml |
| α-CD | 10% | 0.14 mg/ml |
| β-CD | 2% | 0.05 mg/ml |
| γ-CD | 10% | 0.21 mg/ml |
| HPBCD | 10% | 0.19 mg/ml |
| SBE-β-CD | 10% | 0.66 mg/ml |

It is seen that the complexing and resultant increase in solubility is far better for SBE-β-CD than for the other cyclodextrins.

### EXAMPLE 2

### Effect of pH

In this example, the effect of the pH on the solubility of a delphinidin-SBE-β-CD in aqueous solution was investigated. In accordance with the procedure of Example 1, aqueous solutions of SEB-β-CD were prepared, but these solutions were adjusted with 1 M HCL to the acidic pH values specified in Table 2. Then delphinidin chloride was added in accordance with the procedure of Example 1, and operation continued, the only difference being the limiting of the stirring time to 2.5 h. The results are reproduced in Table 2 below.

| | Delphinidin |
|---|---|
| pH | chloride |
| 6.0 | 0.60 mg/ml |
| 4.8 | 2.12 mg/ml |
| 4.1 | 2.03 mg/ml |

It is seen that at pH levels between 4 and 5, the solubility of the complexed delphinidin chloride increases by a factor of around 3 relative to a neutral pH.

### EXAMPLE 3

### Preparation of an Inventive Solid

In this example, an inventive complex is formulated as a solid. For purposes of comparison, a delphinidin/HPBCD complex and also a delphinidin/starch formulation as solid are prepared.

### EXAMPLE 3.1

### Delphinidin/SBE-β-CD

5 g of SEB-β-CD were dissolved in 40 ml of distilled water to form a clear solution. The pH of the solution was adjusted to 4.8 using 1 M HCL. Then 0.11 g of delphinidin chloride was added and the mixture was stirred in the dark at 27° C. for 2 h. The homogeneous liquid was vacuum-filtered through a cellulose nitrate membrane filter with a pore size of 0.45 μm. The solution was frozen and subsequently freeze-dried at −48° C. under a pressure of about 10.3 Pa (77 mtorr). The lyophilizate was ground and screened through a sieve with a mesh size of 0.3 mm.

### EXAMPLE 3.2

### Delphinidin/HPBCD

The procedure was the same as in Example 3.1, but a significant amount of material was retained on filtration, indicating that the solubilization was much less effective than when using SBE-β-CD as in Example 3.1.

### EXAMPLE 3.3

### Delphinidin/Starch Formulation

5 g of starch were suspended in 40 ml of distilled water. This gave a white suspension. The pH of the solution was adjusted to 4.6 using 1 M HCL. Then 0.11 g of delphinidin chloride was added and the mixture was stirred in the dark at 27° C. for 2 h. The homogeneous liquid obtained was freeze-dried, ground, and sieved as in Example 3.1.

Example 3.1 is inventive; Examples 3.2 and 3.3 are comparative examples.

### EXAMPLE 4

### Stability Tests

The solids from Examples 3.1 to 3.3 were stored under the following conditions:
8 days at room temperature in brown glass containers with screw closures;
subsequently 22 days at room temperature in glass containers in the dark under an oxygen atmosphere.

The last 22 days of the storage described above were carried out in glass vials with a volume of 20 ml. 250 mg of each of the samples, already stored previously for 8 days, were introduced into these vials, which were closed and sealed with a rubber stopper. The headspace in the vials was flushed with pure oxygen by means of two injection needles. The samples were subsequently stored in the dark.

The delphinidin content of the solids (calculated as delphinidin chloride and reported in wt %) was determined by means of the HPLC method described above. The results are given in Table 3 below.

| | Passage of time [days] | | | | |
|---|---|---|---|---|---|
| | Start | 2 | 8 | 19 | 30 |
| Example 3.1 | 1.69 | 1.52 | 1.55 | 1.40 | 0.93 |
| Example 3.2 | 1.30 | 1.20 | 1.14 | 1.03 | 0.68 |
| Example 3.3 | 1.60 | 1.59 | 1.56 | 1.53 | 1.15 |

The results show that in accordance with the invention a delphinidin complex can be prepared which even under a pure oxygen atmosphere possesses a high stability and hence good storage qualities. The complex further possesses ready solubility in aqueous solutions, especially slightly acidic solutions, allowing delphinidin to be formulated in a wide variety of ways in accordance with the invention. The stability of the solid of the invention is of similar quality to that of a formulation with starch (Example 3.3), but this comparative example cannot be formulated in an aqueous solution.

### EXAMPLE 5

### Stability Tests in Aqueous Solution

The delphinidin chloride content of the delphinidin-containing solutions was determined using a reversed-phase HPLC technique similar to that already described above. The following reagents were employed here:

Purified water

Methanol for chromatography

Formic acid, p.a.

1 M hydrochloric acid as volumetric solution.

The column used was a Waters X Bridge™ C18, 35 μl, 150 mm×4.6 mm.

The mobile phases were as follows:

Channel A: water 770 ml, methanol 230 ml, formic acid 10 ml

Channel B: water 50 ml, methanol 950 ml, formic acid 10 ml

The following gradient program was used:

| Time | Percent |
|---|---|
| [min] | channel B |
| 0 | 0 |
| 5 | 0 |
| 20 | 20 |
| 25 | 100 |

Stop time: 25 min

Post-time: 8 min

Flow rate: 1 ml/min

Injection volume: 20 μl

Column temperature: 30° C. +/−2° C.

UV-Vis detector: 530 μm for the assay, 275 μm for the detection of impurities

Integrator: area

Solutions and Sample Preparation:

Diluent solution 1: mixture of 100 ml methanol and 2.6 ml 1 M HCL

Diluent solution 2: mixture of 100 ml 50% strength methanol and 2.6 ml 1 M HCL

Calibrating solution: a reference solution of delphinidin was prepared by weighing out 10 mg of delphinidin chloride into a 10 ml flask and dissolving it in diluent solution 1. Dissolution was followed by approximately 10-fold dilution with diluent solution 2, to produce an approximate concentration of 0.1 mg/ml.

The control calibrating solution was prepared in the same way. The calibrating solutions were analyzed immediately by HPLC, since delphinidin chloride in solution is unstable.

Preparation of the Test Solutions:

For the purpose of determining the delphinidin content of an inventive aqueous solution, delphinidin/SBE-β-CD from Example 3.1 (inventive) and delphinidin (comparative example) were dissolved in 0.9% strength NaCl solution until the starting concentration established (based on the delphinidin) was 1.584 mg/ml (inventive example) or 0.0216 mg/ml (comparative example). The solutions were prepared at room temperature and then stored in closed vials in the dark at 37° C.

The delphinidin content was determined after 1, 2, 3, and 4 h. The table below reports the content found, as a percentage of the abovementioned starting concentration.

| Time | Delphinidin | Delphinidin/ |
|---|---|---|
| [h] | uncomplexed | SBE-β-CD |
| 0 | 100% | 100% |
| 1 | 8.3% | 80.7% |
| 2 | 6.5% | 74.5% |
| 3 | 5.6% | 64.7% |
| 4 | 5.1% | 62.8% |

The determination of the delphinidin content in the samples was calculated with the aid of the Agilent ChemStation software, employing calibration with the external standard described.

II. Effect of the Anthocyanidin Delphinidin on Bacteria

1. Test Strains and Experimental Setup

The strains selected were as follows:
Pseudomonas aeruginosa ATCC9027, biofilm-positive clinical isolate from an outer ear infection (reference strain);

Klebsiella pneumoniae ATCC700603 biofilm-positive clinical isolate from urine from an ESBL+(Extended Spectrum Beta-Lactamase) hospital patient (reference strain);

Staphylococcus aureus MRSA2318 biofilm-positive clinical isolate from tracheal secretion of 22.04.2009 (Würzburg University Hospital, neurosurgical clinic and polyclinic I, intensive therapy unit);
Staphylococcus aureus MRSA2855 biofilm-positive clinical isolate from blood culture of 22.04.2009 (Würzburg University Hospital, medical clinic and polyclinic I, ITU);
Staphylococcus aureus MSSA1155 biofilm-positive clinical isolate from 27.04.2004 from abdominal cavity scrape (Würzburg University clinic, urology, unit B).

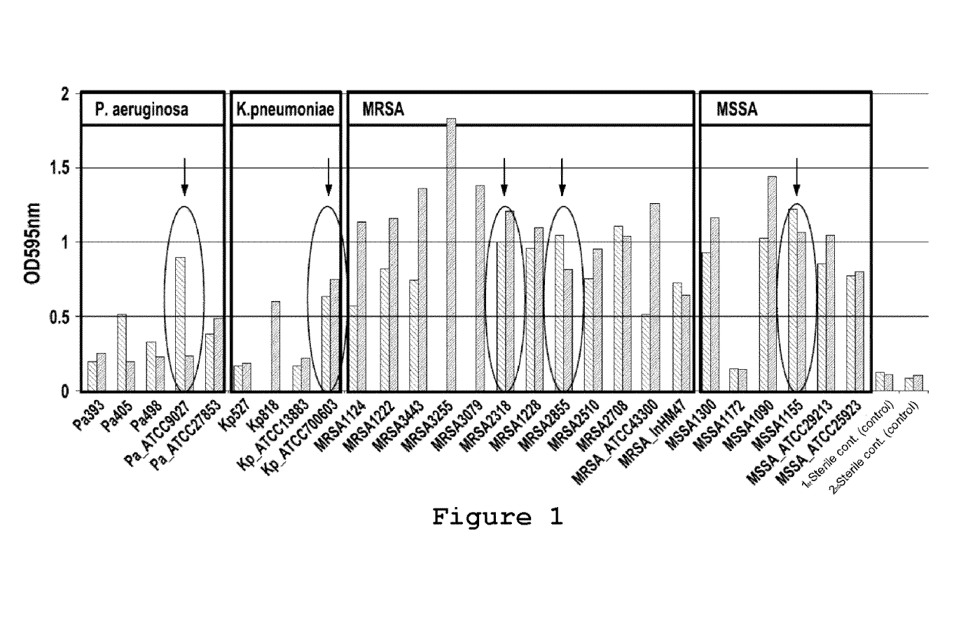

On account of their pronounced biofilm formation, the aforementioned strains were selected as being particularly suitable for investigating the effect of the compositions of the invention on bacteria, as is evident from FIG. 1.

FIG. 1 shows the results of a static formation of biofilm after 48 hours for various strains of the species Pseudomonas aeruginosa and Klebsiella pneumoniae and also MRSA and MSSA strains in two independent experiments. The growth and the analysis of the biofilm were determined in a static model by means of the crystal violet assay according to basic protocol 1 in Current Protocols in Microbiology 1B.1.2-1B.1.4 “MICROTITER PLATE BIOFILM ASSAY” [published online August 2011 in Wiley Online Library (wileyonlinelibrary.com) DOI: 10.1002/9780471729259. mc01b01s22].

2. Active Ingredient Analysis

Investigating the effect of delphinidin on the bacterial growth and the bacterial formation of biofilm took place by means of
a) visual evaluation of bacterial growth (static model),
b) vitality test (scrape on blood agar plates)
c) analysis of the biofilm in a static model by means of the crystal violet assay as described above in section 1.

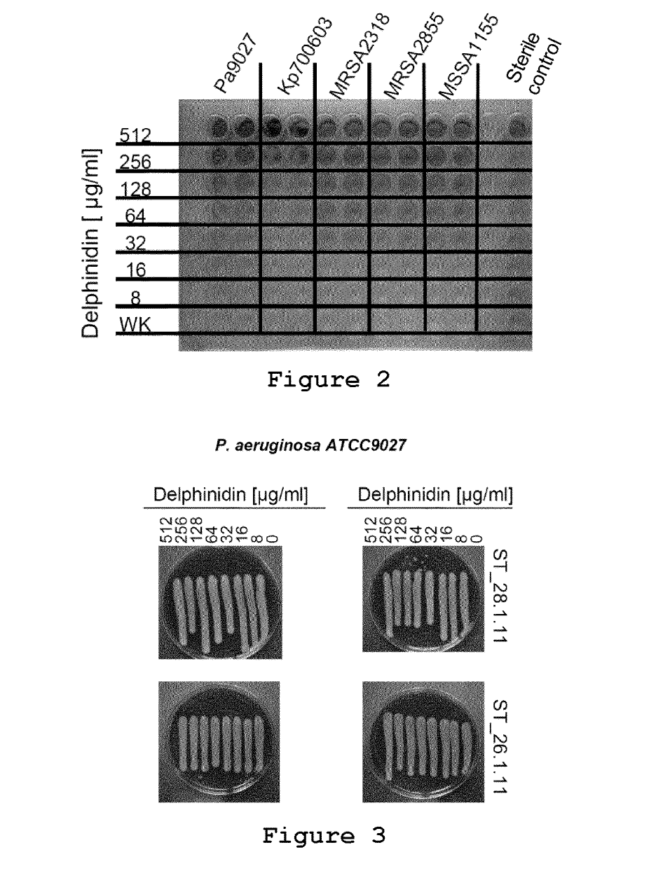

First, 1×10⁶ bacteria/well were introduced in 100 μl of RPMI-1640 cell medium, with phenol red as pH indicator (and hence as an indirect indicator of bacterial growth), in a 96-well polystyrene cell culture dish. The control used was sterile RPMI-1640. Then delphinidin in solution in RPMI-1640 was added, from a dilution series produced beforehand, and the cell culture dish was incubated at 37° C. for 48 hours, the visual outcome thereof being shown in FIG. 2. The color change from (phenol) red to yellow correlates with the extent of the bacterial growth.

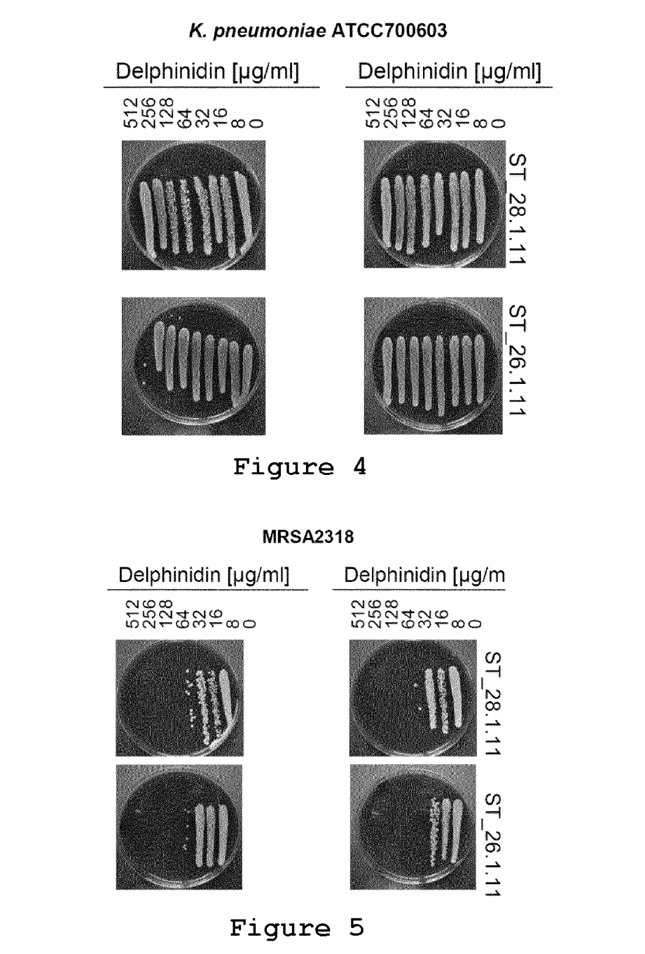

Scrapes of the bacteria from the culture dish are shown in FIG. 3 (P. aeruginosa ATCC9027), 4 (K. pneumoniae ATCC700603), 5 (MRSA2318), 6 (MRSA2855) and 7 (MSSA1155). “ST 26.1.11” and “ST 28.1.11” in the case of the scrapes on the agar plates refers to the respective scraping date of the duplicated experiments.

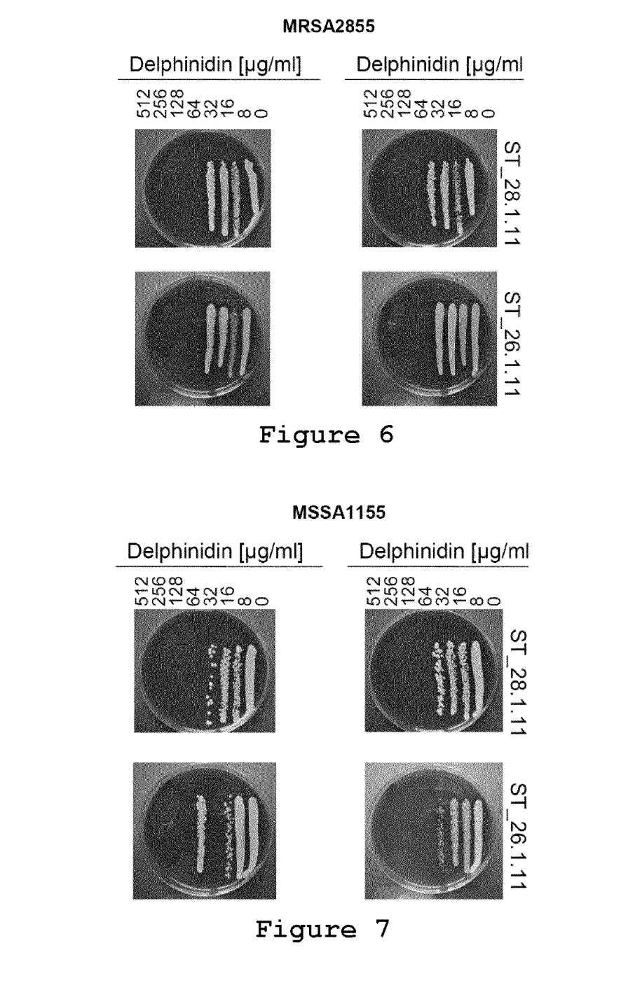

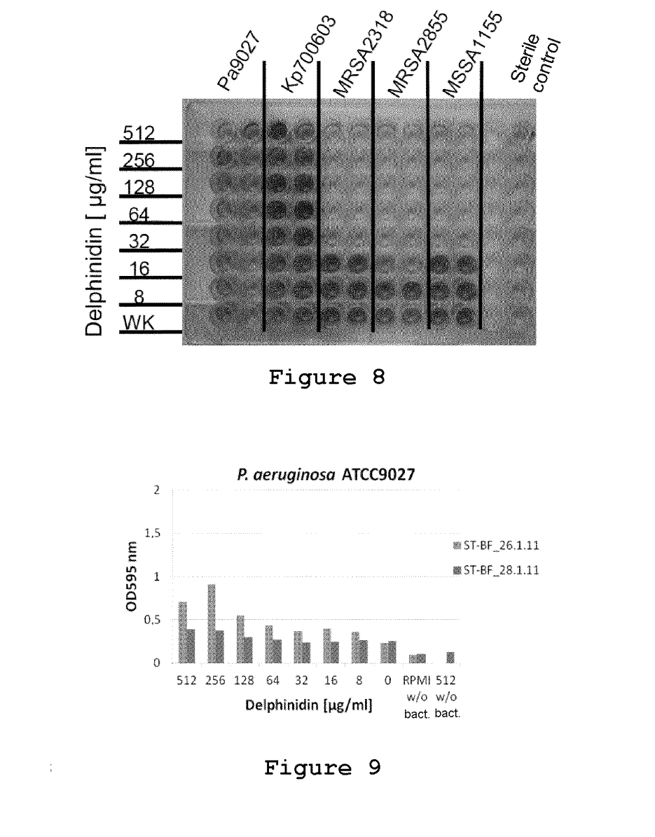

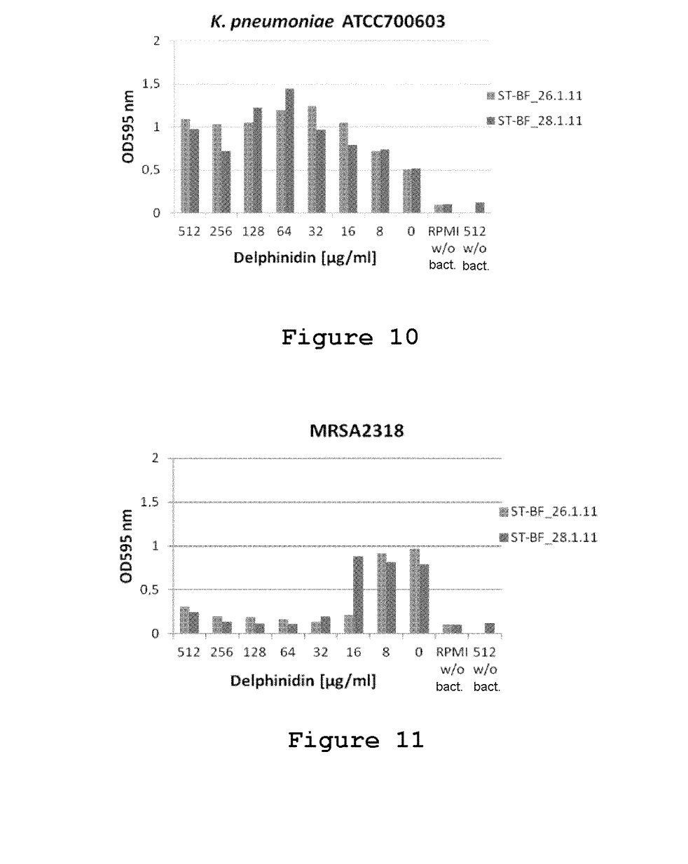

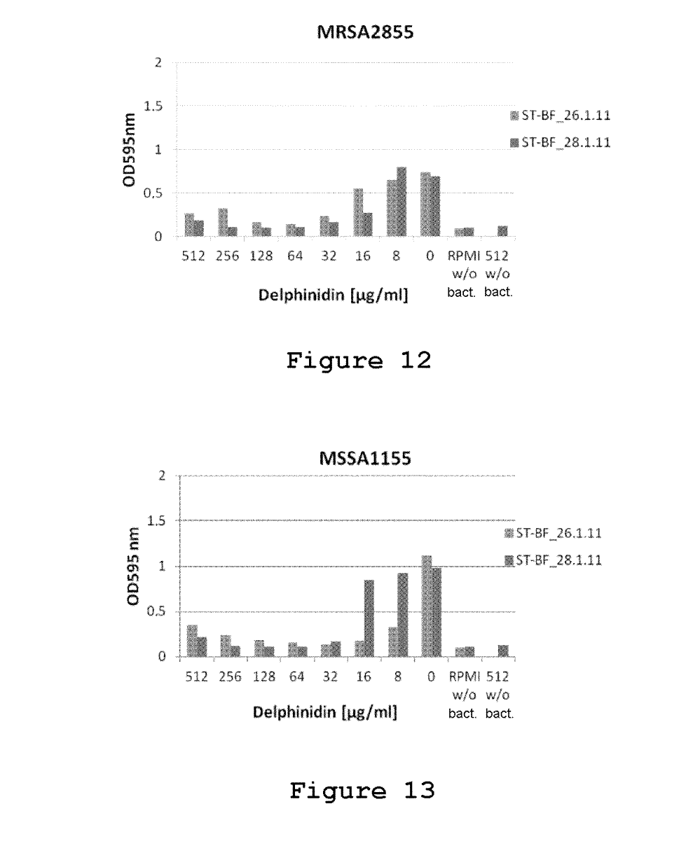

With the same experimental setup, the biofilm was analyzed by means of the crystal violet test as described above in section 1, the outcome thereof, after 48 hours of incubation and the crystal violet test, is shown overall in FIG. 8, and in FIGS. 9-13 in each case after measurement of the optical density, processed graphically for the respective delphinidin concentrations in the case of the individual bacterial strains (FIG. 9: P. aeruginosa ATCC9027, FIG. 10: K. pneumoniae ATCC700603, FIG. 11: MRSA2318, FIG. 12: MRSA2855, FIG. 13: MSSA1155).

The experimental results can be summarized as follows:
Delphinidin possesses no inhibiting effect on the growth and the formation of biofilm of the gram-positive bacteria P. aeruginosa and K. pneumoniae. In the case of K. pneumoniae, the formation of biofilm in fact appears still to be being stimulated.

In contrast, delphinidin possesses an inhibiting effect both on growth and on the formation of biofilm by S. aureus (both MSSA and MRSA). This effect exhibits dose-dependent decrease.

1-13. (canceled)

14. A method of treating an object that is not a live animal, said object contaminated with bacteria selected from the group consisting of antibiotics-resistant Staphylococcus aureus and antibiotics-sensitive Staphylococcus aureus, comprising administering or applying to said object delphinidin or salts thereof, or with a complex comprising delphinidin.

15. The method of claim 14, wherein said treating said object leads to neutralization of said bacteria, said neutralization comprising destruction, disintegration, inactivation, or prevention of reproduction of said Staphylococcus aureus bacteria, or prevention of Staphylococcus aureus-mediated biofilm formation.

16. The method of claim 14, wherein said antibiotics-resistant Staphylococcus aureus is resistant to an antibiotic selected from the group consisting of
β-lactam antibiotics,
quinolones,
tetracyclines,
aminoglycosides,
erythromycin,
sulfonamides, and
vancomycin.

17. The method of claim 16, wherein a β-lactam antibiotic is selected from the group consisting of penicillin, cephalosporins, carbapenems, and monobactams.

18. The method of claim 14, comprising providing delphinidin or salts thereof or said complex comprising delphinidin in an aqueous solution or in a solid.

19. The method of 18, wherein said aqueous solution or said solid are in the form of an additive for producing a rinsing solution or a solid formulation for said administering or applying.

20. A method for treating an object, the object not being a live animal, comprising:
a) providing:
i) a preparation comprising delphinidin or salts thereof or a complex comprising delphinidin, or an aqueous solution or solid comprising delphinidin or salts thereof or a complex comprising delphinidin; and
ii) an inanimate object suspected of being contaminated with bacteria selected from the group consisting of antibiotics-resistant Staphylococcus aureus and antibiotics-sensitive Staphylococcus aureus;
and
b) treating said inanimate object with said preparation under conditions wherein said bacteria suspected of contaminating said inanimate object are at least partially destroyed or disintegrated or inactivated, or wherein Staphylococcus aureus-mediated biofilm formation is prevented.

21. The method of claim 20, wherein said inanimate object is an animal body or a part thereof.

22. The method of claim 21, wherein said animal body or a part thereof is selected from the group consisting of
a body of a bovine, or a part thereof,
a body of a pig, or a part thereof,
a poultry body, or a part thereof, and
a body of a water-dwelling animal, or a part thereof.

23. The method of claim 20, wherein said inanimate object is a food and/or feed.

24. The method of claim 23, wherein said food and/or feed is selected from the group consisting of:
a meat product,
a processed meat product,
a dairy product,
vegetables, and parts thereof, and
fruit, and parts thereof.

25. The method of claim 20, wherein said inanimate object is selected from the group consisting of:
a) apparatus and/or installations and/or equipment and/or instruments for
medical applications,
food processing, and
the military,
b) protective equipment,
c) domestic objects,
d) building installations, and
e) construction works.

26. A method of treating an object suspected of being infected with antibiotics-resistant or antibiotics-sensitive bacteria of the species Staphylococcus aureus, comprising administering or applying to said object delphinidin or salts thereof, or a complex comprising delphinidin, or an aqueous solution or solid comprising delphinidin or salts thereof or a complex comprising delphinidin.

27. A method of prophylaxis or treatment of a human or animal suspected of being infected with antibiotics-resistant or antibiotics-sensitive bacteria of the species Staphylococcus aureus, comprising administering or applying to said human or animal delphinidin or salts thereof, or a complex comprising delphinidin, or an aqueous solution or solid comprising delphinidin or salts thereof or a complex comprising delphinidin.

28. The method of claim 27, wherein infection of a human or animal by said bacteria causes diseases with symptoms selected from the group consisting of:
skin infections,
pyomyositis,
pneumonia,
endocarditis,
toxic shock syndrome,
sepsis, and
mastitis.

29. The method of claim 28, wherein said skin infections comprise boils and/or carbuncles.

30. The method of any one of claim 14, 20, 26 or 27, wherein said complex comprising delphinidin comprises sulfoalkyl ether-β-cyclodextrin having a degree of substitution of the cyclodextrin by sulfoalkyl ether groups of 3 to 8.

31. The method of claim 30, wherein said sulfoalkyl ether-β-cyclodextrin is a sulfobutyl ether-β-cyclodextrin.

32. The method of claim 30, wherein said degree of substitution is 4 to 8.

33. The method of claim 30, wherein said degree of substitution is 5 to 8.

34. The method of claim 30, wherein said degree of substitution is 6 to 7.
